(19) United States
(12) Patent Application Publication
(10) Pub. No.: US 2019/0127186 A1
(43) Pub. Date: May 2, 2019

(54) SELF-CONTAINED HOIST DEVICE, RAIL DEVICE AND HOIST SYSTEM

(71) Applicant: UPCLIMBER, København SV (DK)

(72) Inventors: Andreas LOLLE, København (DK); Steffen NIELSEN OSTERBERG, København (DK)

(73) Assignee: UpClimber, København SV (DK)

(21) Appl. No.: 16/091,941

(22) PCT Filed: Apr. 6, 2017
(86) PCT No.: PCT/DK2017/000005

§ 371 Date: Oct. 5, 2018

(30) Foreign Application Priority Data
Apr. 11, 2016 (DK) PA201600217

(51) Int. Cl. B66C 7/04; B66C 1/02; B66C 11/04; B66D 1/60; B66D 3/20

(52) U.S. Cl. CPC B66C 7/04; B66C 1/0243; B66C 9/14; B66D 1/605; B66D 3/20; B66C 11/04

(57) ABSTRACT

A self-contained hoist device, rail device and hoist system for hoisting building materials, comprising a housing; and lifting beam extending from the housing; wherein a hoist motor for driving a winch provided with a hoisting wire and a battery pack for powering the hoist motor are arranged inside the housing, and a distal end of the hoisting wire is adapted to be attached to a fixing point above the self-contained hoist device, whereby operation of the hoist motor may cause the housing and lifting beam to be raised and lowered, respectively.

### FIELD OF THE INVENTION

The present invention relates to a self-contained hoist device, a rail device and a hoist system for hoisting building materials.

### BACKGROUND OF THE INVENTION

Mounting windows and lifting building materials can be cumbersome and heavy lifting may be subject to local regulations and statutory requirements. Therefore, it is desirable to avoid or at least reduce the need for heavy lifting. Technical aids may be used to reduce heavy lifting, however if such aids reduce work efficiency and are not easily used in shifting working routines, these are usually not adapted. Also, on a construction site electrical power is not always widely available. Use of electrically driven devices requiring the supply of external power may therefore require additional cables to be installed, which is time-consuming and may delay operations. Battery operated devices are therefore often preferred over mains powered devices. Hence, an improved hoist device would be advantageous, and in particular a more efficient and flexible to use hoist device would be advantageous.

### OBJECT OF THE INVENTION

An object of the present invention is to wholly or partly overcome the above disadvantages and drawbacks of the prior art. More specifically, it is an object to provide a hoist device and a hoist system that is easy to handle and can be used independently of existing infrastructure, such as supply of electrical power.

### SUMMARY OF THE INVENTION

Thus, the above described object and several other objects are intended to be obtained in a first aspect of the invention by providing a self-contained hoist device for hoisting building materials, comprising a housing; and lifting beam extending from the housing; and a hoist motor for driving a winch provided with a hoisting wire and a battery pack for powering the hoist motor being arranged inside the housing, wherein the housing is further provided with a pivotally mounted pivot arm comprising one or more guides for guiding the hoisting wire, the pivot arm being adapted to be locked in a forward position by a locking mechanism to control a centre of gravity of the housing, lifting beam and an associated payload, and wherein a distal end of the hoisting wire is adapted to be attached to a fixing point above the self-contained hoist device, whereby operation of the hoist motor may cause the housing and lifting beam to be raised and lowered, respectively.

Hereby a self-contained hoist device requiring no external supply of power is provided. The only external connection required for operating the hoist device is a fixing point for securing the distal end of the hoisting wire. Accordingly, the entire hoist device is lifted together with the associated payload, thereby providing a hoist device that is flexible in use and easy to operate.

In one embodiment of the self-contained hoist device, the lifting beam may comprise two vacuum cups for being secured to a window surface and the lifting beam may be adjustable in a transversal direction to control a distance (D) between the vacuum cups.

In addition, the self-contained hoist device may further comprise one or more handles extending from the housing, the one or more handles being provided with a switch device for controlling the operation of the hoist motor to drive the winch.

Furthermore, the one or more handles may be provided with a lever device for controlling the locking mechanism to release the pivot arm.

The invention further relates to a hoist system comprising a self-contained hoist device as described above and a rail device, the rail device comprising a rail element extending in a longitudinal direction and being adapted for receiving a trolley movable in the longitudinal direction, the trolley being adapted to provide a fixing point for the hoisting wire, whereby the hoist device and an associated payload may be moved in the longitudinal direction. Additionally, the rail device may further comprise a mounting mechanism for attaching the rail device underneath a platform element of a scaffold

These and other aspects of the invention will be apparent from and elucidated with reference to the embodiments described hereinafter.

### BRIEF DESCRIPTION OF THE FIGURES

The hoist device according to the invention will now be described in more detail with regard to the accompanying figures. The figures show one way of implementing the present invention and is not to be construed as being limiting to other possible embodiments falling within the scope of the attached claim set.

FIG. 1 shows a self-contained hoist device,

FIG. 2 shows the self-contained hoist device seen towards the front,

FIG. 3 shows the self-contained hoist device seen from the side,

FIGS. 4a and 4b show details of the locking mechanism for locking the pivot arm,

FIG. 5 shows the self-contained hoist device with the vacuum cups secured to a window,

FIGS. 6a and 6b illustrates the functionality of the pivot arm during installation of a window,

FIGS. 7a and 7b shows the construction of a rail device, and

FIG. 8a-8d illustrates the functionality of the rail device.

### DETAILED DESCRIPTION OF AN EMBODIMENT

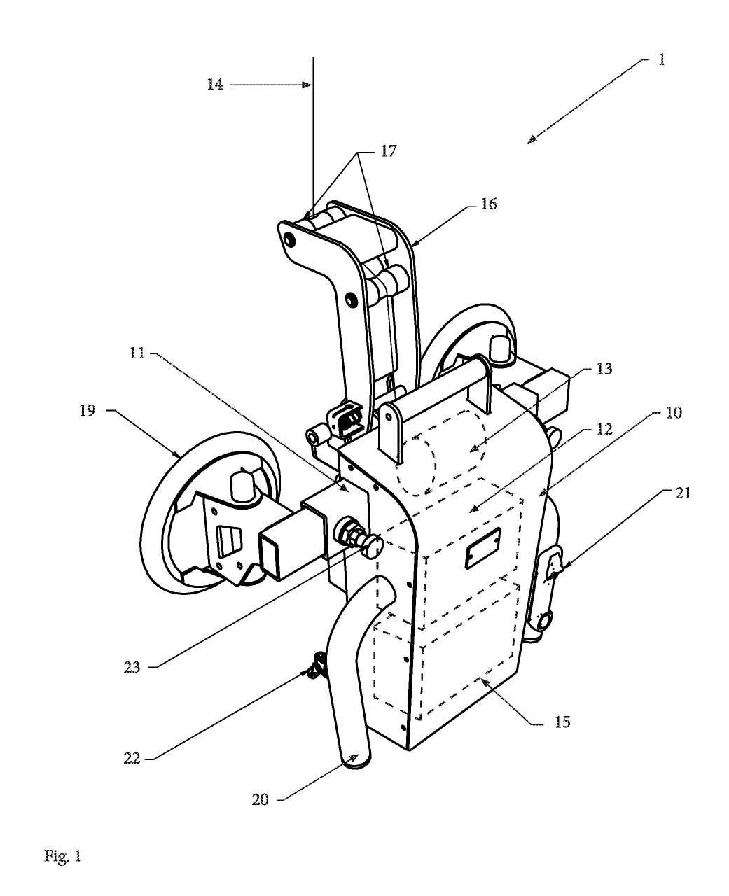

FIG. 1 shows a self-contained hoist device comprising a housing 10 and a lifting beam 11 extending from the housing in a transversal direction. In the shown embodiment the lifting beam is provided with vacuum cups 19 for being secured to a window surface or other smooth surface. In other embodiments the lifting beam may be provided with alternative arrangements (not shown) for lifting other building materials, supplies or other artefacts. Inside the housing a hoist motor 12, a winch 13 and a battery pack 15 is arranged. The winch is provided with a hoisting wire 14 and the hoist motor is arranged to drive the winch to extract or retract the hoisting wire. The battery pack 15 is electrically connected with the hoist motor and sufficient control electronics for controlling operation of the motor and winch. Also, the battery pack stores sufficient energy to power the hoist motor during operation of the hoist device and the battery pack may be recharged by being connected to an external power. Recharging of the battery may require the use of an external power converter or a power converter may be integrated in the hoist device.

As seen from FIG. 1-3 the housing is provided with a pivotally mounted pivot arm 16. The pivot arm extends in a lateral direction and is shaped reach around a payload secured to the lifting beam. In the shown embodiment the pivot arm is L-shaped with a first straight section being pivotally mounted on the housing and a second shorter section extending in a direction perpendicular to the first section. The pivot arm further comprises two guides 17 in the form of guide wheel for controlling the extension of the hoisting wire 14. The hoisting wire extends from the winch around the first guide wheel and around the second guide wheel. Hereby the course of the hoisting wire is changed, which affects the position of the centre-of-gravity of the housing 10, lifting beam 11 and an associated payload 100 as will be further described below.

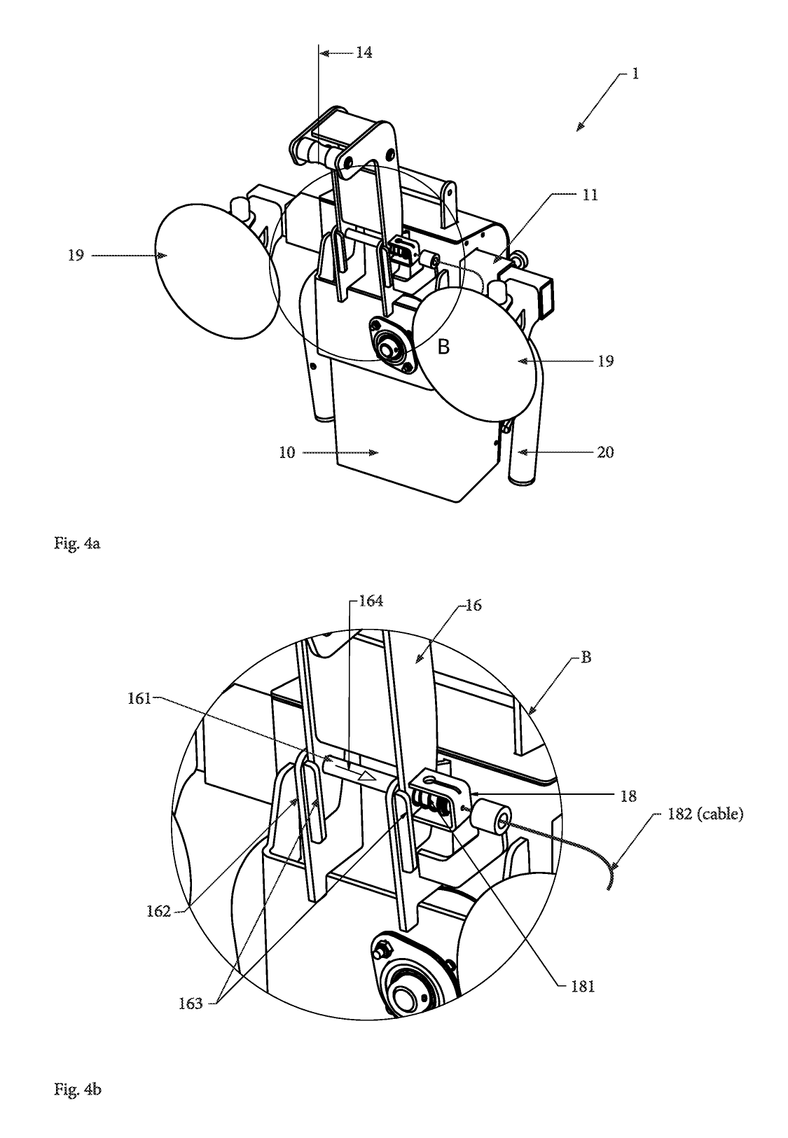

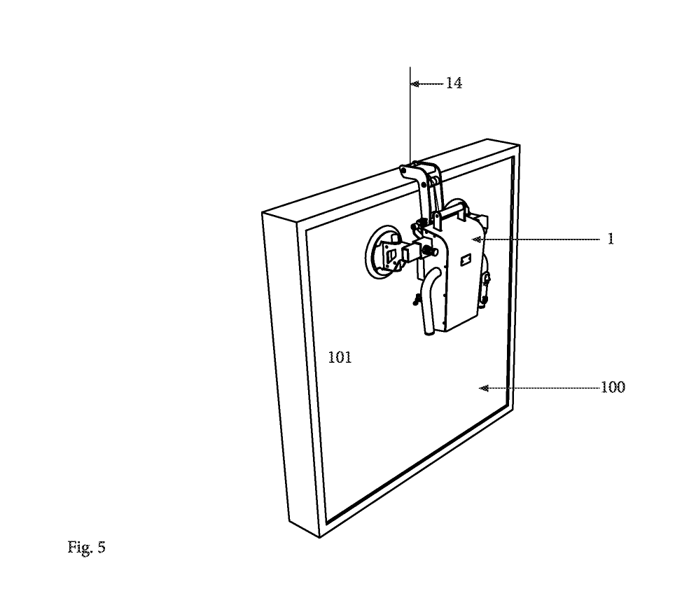

Referring to FIGS. 6a and 6b, the pivot arm is adapted to move between a forward position as shown in FIG. 6a and a backwards leaning position as shown in FIG. 6b. Further, the pivot arm may be locked in the forward position by a locking mechanism 18 shown in greater detail in FIG. 4b.

When a payload is secured to the lifting beam as shown in FIG. 5 and the pivot arm is locked in the forward position, the center-of-gravity is displaced, compared to a situation where the pivot arm can move freely and consequently is forced into the backwards leaning position, amongst others due to the weight of the payload 100.

When the payload is a window the centre-of-gravity 102 is advantageously displaced by locking the pivot arm in the forward position as shown in FIG. 6a. The displacement of the centre-of-gravity affects the orientation of the window and as seen from the figure, and the window hangs in an inclined position with the lower most part of the window the furthest away from the lifting device. In other words, an upper edge of the window is tilted towards a user operating the hoist device and a lower edge of the window is tilted away from the user. This orientation of the window is advantageously during installation of windows as the window can be arranged with its lower edge resting on the windowsill or other structure adapted to receive the window. By the window being supported at its lower edge, the window can relatively easily be pushed into place without the need for heavy lifting by the user.

Referring to FIG. 6b, before the window can be pushed into the window opening, the pivot arm has to be moved backwards. This is done by de-activating the locking mechanism keeping the pivot arm in the forward position. When the locking mechanism is de-activated the pivot arm is released and can now freely move backwards to make room for arranging the window in a window opening or the like. In FIG. 4a, the circle B indicates the position of the locking mechanism adapted to lock the pivot arm in the forward position. In FIG. 4b the locking mechanism is shown in greater detail. The pivot arm 16 is mounted using a pin 161 secured to an extension 162 of the housing. The locking mechanism 18 includes a spring element 181 forcing the pivot arm towards the position shown in FIG. 4b. When the pivot arm is in the locked position as shown in FIG. 4b, plate elements 163 prevent the pivot arm 16 from rotating backwards. A lever device 22 arranged on a handle of the hoist device as shown in FIG. 1 is connected with cable 182 and the lever device may be activated to de-activate the locking mechanism. Activation of the lever device causes a tightening of cable 182, which results in the pivot arm being pulled in the direction of the arrow 164. The pivot arm thus moves along the pin 161 and when the pivot arm clears the plate elements 163, the pivot arm may rotate backwards towards the backwards leaning position as shown in FIG. 6b. The skilled person would know that the locking mechanism and mechanism for de-activating the locking mechanism may be designed in a number of other ways without departing from the scope of the invention.

Referring to FIG. 1-3, in one embodiment the hoist device is provided with two handles 20 extending from the housing. On one of the handles the above mentioned lever device for de-activating the locking mechanism is provided, and on the other handle a switch device 21 for controlling the operation of the hoist motor is provided. In an alternative embodiment the lever device and switch device may be arranged on the same handle or in other positions associated with the housing. When the switch device is operated the winch rotates to either extract or retract the hoisting wire and by arranging the switch device and the lever device on the handles of the housing, the hoist device is easily controlled by one person, while keeping full control of the payload. Prior art system often requires the operator to operate the hoist mechanism with one hand while controlling the payload with the other. This may be a difficult task, especially during demanding operating conditions and due to the weight and geometry of the payload.

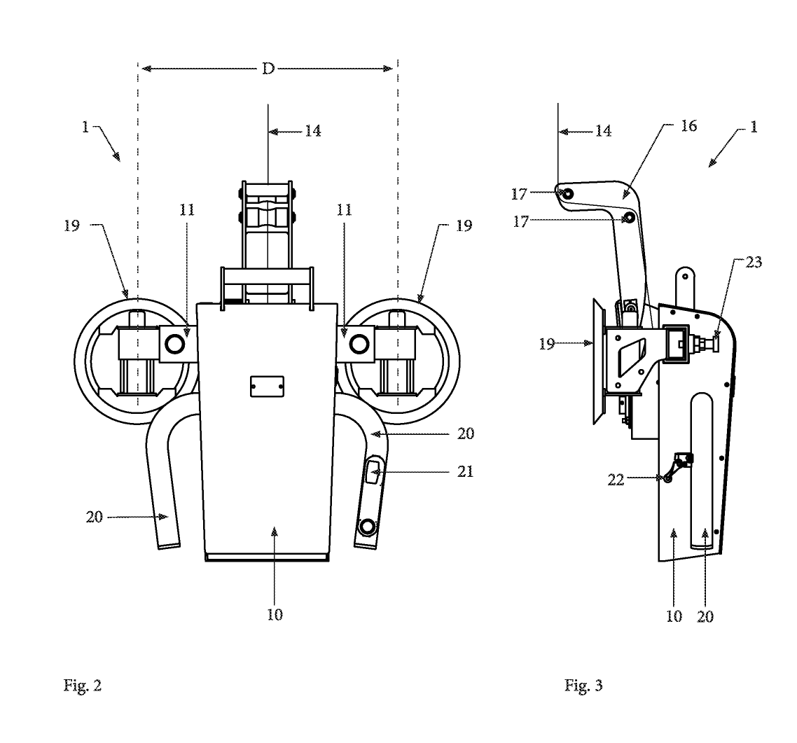

As previously described the lifting beam is provided with vacuum cups 19. The lifting beam is adjustable in a transversal direction to control a distance (d) between the vacuum cups 19 as shown in FIG. 2. By controlling the distance between the vacuum cups, the lifting beam may be adjusted to correspond to the geometries of various payloads. The lifting beam is adjusted and the vacuum cups displaced by operating an indexing plunger 23 locking a displaceable part of the lifting beam in position as best seen in FIG. 3.

During operation of the self-contained hoist device a distal end of the hoisting wire 14 is attached to a fixing point located above the hoist device. Hereby, operation of the hoist motor may cause the housing and lifting beam to be raised and lowered, respectively. A fixing point may be any structure suitable for securing a cable, such as an eye bolt, a beam or the like.

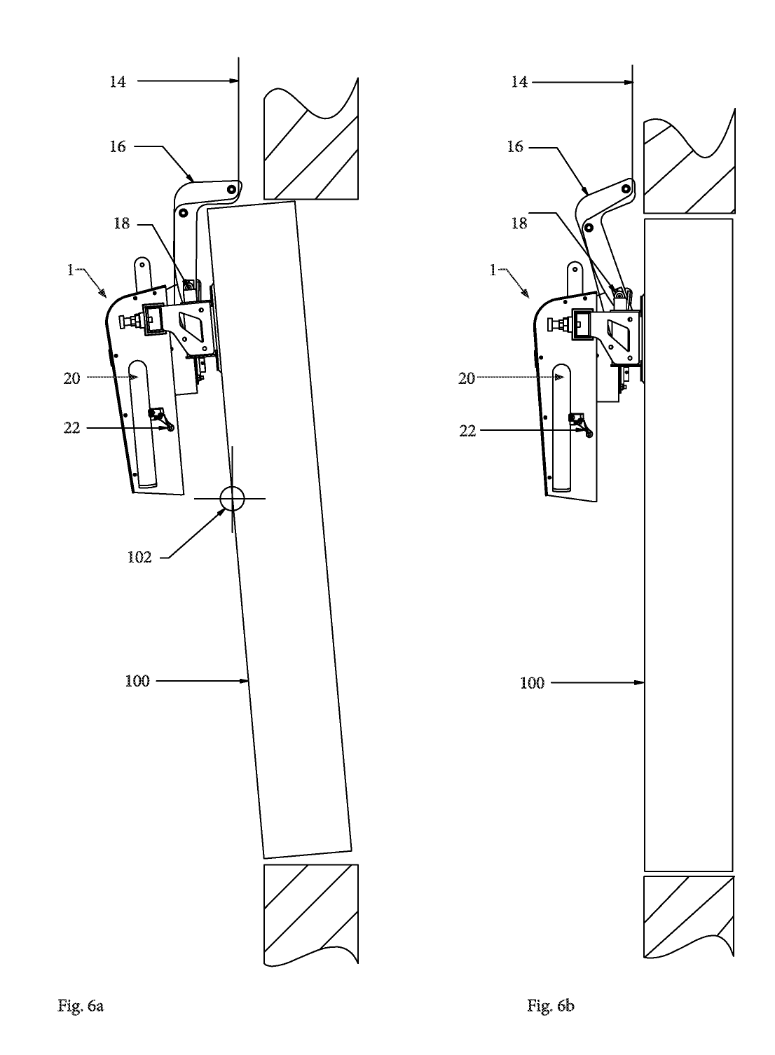

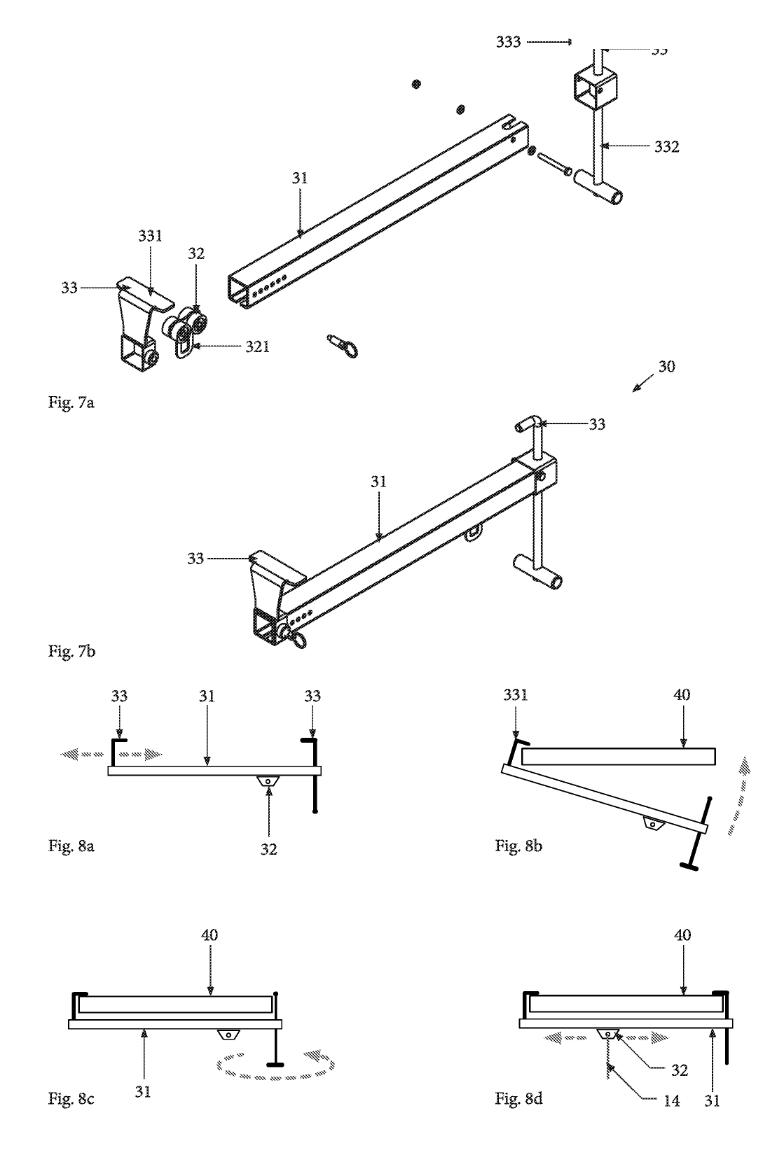

FIG. 7a shows a rail device 30 comprising a rail element 31 adapted for receiving a trolley 32 movable along the rail element in a longitudinal direction. The trolley comprises an eye bracket 321 for receiving a distal end of the hoisting cable. Thereby the hoist device and an associated payload may move along the rail element during hoisting operations. The rail device comprises a mounting mechanism 33 for attaching the rail element underneath a fixed structure, such as a platform element 40, deck or walking board of a scaffold. The mounting mechanism is provided by a gripping element 331 in the form of a bracket adapted for reaching around a first edge of a platform element as shown in FIG. 8a-8d. Similarly, a rotatable handle 332 providing a second bracket is provided in an opposite end of the rail element, for reaching around a second opposite edge of the platform element 40. Referring to FIGS. 8b and 8c, when the gripping element 331 or first bracket has been arranged to engage with the first edge, the rail element is moved upwards into a position parallel with the platform element. When the rail element is aligned with the platform element the handle 332 is rotated so that a gripping arrangement 333 or second bracket of the handle 332 reaches around the second edge of the platform element to lock the rail device in place. Referring to FIG. 8d, the hoisting wire may now be fixed to eye bracket to provide a fixing point for the self-contained hoist device.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A self-contained hoist device for hoisting building materials, comprising:
a housing;
a lifting beam extending from the housing;
a winch arranged in the housing and being provided with a hoisting wire having a distal end adapted for being attached to a fixing point above the self-contained hoist device;
a hoist motor for driving the winch; and
a battery pack for powering the hoist motor,
the self-contained hoist device characterized in that the housing is provided with a pivotally mounted pivot arm comprising one or more guides for guiding the hoisting wire, the pivot arm being adapted to be locked in a forward position by a locking mechanism to control a center of gravity of the housing, the lifting beam and an associated payload.

2. The self-contained hoist device according to claim 1, wherein the lifting beam comprises two vacuum cups for being secured to a window surface and wherein the lifting beam is adjustable in a transversal direction to control a distance between the vacuum cups.

3. The self-contained hoist device according to claim 1, further comprising one or more handles extending from the housing, the one or more handles being provided with a switch device for controlling the operation of the hoist motor to drive the winch.

4. The self-contained hoist device according to claim 3, wherein the one or more handles are provided with a lever device for controlling the locking mechanism to release the pivot arm.

5. A rail device adapted for being secured underneath a scaffold deck element, the rail device comprising:
a rail element extending in a longitudinal direction; and
a mounting mechanism for attaching the rail device underneath a platform element of a scaffold, wherein the rail element is adapted for receiving a trolley movable in the longitudinal direction, the trolley being adapted to provide a movable fixing point.

6. The rail device according to claim 5, wherein the mounting mechanism comprising:
a first bracket provided at one end of the rail element, for being arranged around an edge of the platform element; and
a second bracket provided at an opposite end of the rail element, for being arranged around an opposite edge of the platform element, wherein the second bracket is rotatable and provided with a handle for rotation into engagement with the edge of the scaffold deck element.

7. The rail device according to claim 6, wherein the first bracket is displaceable in the longitudinal direction of the rail element.

8. A hoist system comprising:
a self-contained hoist device for hoisting building materials, comprising:
a housing;
a lifting beam extending from the housing;
a winch arranged in the housing and being provided with a hoisting wire having a distal end adapted for being attached to a fixing point above the self-contained hoist device;
a hoist motor for driving the winch; and
a battery pack for powering the hoist motor,
the self-contained hoist device characterized in that the housing is provided with a pivotally mounted pivot arm comprising one or more guides for guiding the hoisting wire, the pivot arm being adapted to be locked in a forward position by a locking mechanism to control a center of gravity of the housing, the lifting beam and an associated payload; and
a rail device adapted for being secured underneath a scaffold deck element, the rail device comprising:
a rail element extending in a longitudinal direction; and
a mounting mechanism for attaching the rail device underneath a platform element of a scaffold, wherein the rail element is adapted for receiving a trolley movable in the longitudinal direction, the trolley being adapted to provide a movable fixing point for the hoisting wire, whereby the self-contained hoist device and the associated payload may be moved in the longitudinal direction.

9. The hoist system according to claim 8, wherein the lifting beam comprises two vacuum cups for being secured to a window surface and wherein the lifting beam is adjustable in a transversal direction to control a distance between the vacuum cups.

10. The hoist system according to claim 9, wherein the self-contained hoist device comprises one or more handles extending from the housing, the one or more handles being provided with a switch device for controlling the operation of the hoist motor to drive the winch.

11. The hoist system according to claim 10, wherein the one or more handles are provided with a lever device for controlling the locking mechanism to release the pivot arm.

12. The hoist system according to claim 8, wherein the self-contained hoist device comprises one or more handles extending from the housing, the one or more handles being provided with a switch device for controlling the operation of the hoist motor to drive the winch.

13. The hoist system according to claim 12, wherein the one or more handles are provided with a lever device for controlling the locking mechanism to release the pivot arm.

14. The hoist system according to claim 8, wherein the mounting mechanism comprises:
a first bracket provided at one end of the rail element, for being arranged around an edge of the platform element; and
a second bracket provided at an opposite end of the rail element, for being arranged around an opposite edge of the platform element, wherein the second bracket is rotatable and provided with a handle for rotation into engagement with the edge of the scaffold deck element.

15. The hoist system according to claim 14, wherein the first bracket is displaceable in the longitudinal direction of the rail element.

16. The self-contained hoist device according to claim 2, further comprising one or more handles extending from the housing, the one or more handles being provided with a switch device for controlling the operation of the hoist motor to drive the winch.
